(19) United States
(12) Patent Application Publication
(10) Pub. No.: US 2026/0336533 A1
(43) Pub. Date: Oct. 29, 2026

(54) SEAT ASSEMBLY, TRIM CLIP, AND METHOD OF ASSEMBLY

(71) Applicant: Lear Corporation, Southfield, MI (US)

(72) Inventors: Michael Schwalm, Auburn Hills, MI (US); Michelle A. Brudzynsky, West Bloomfield, MI (US); Mark Karges, Macomb, MI (US); Joshua Hallock, Warren, MI (US)

(73) Assignee: Lear Corporation, Southfield, MI (US)

(21) Appl. No.: 19/553,741

(22) Filed: Mar. 2, 2026

Related U.S. Application Data
(60) Provisional application No. 63/793,068, filed on Apr. 23, 2025.

(51) Int. Cl. B60R 13/02

(52) U.S. Cl. CPC B60R 13/0206

(57) ABSTRACT

A seat assembly, a trim clip, and a method of assembly. The seat assembly comprises a cushion, a trim cover, and a trim clip. The trim clip comprises a hub, an arm, and an attachment feature that is coupled to the trim cover. One or more arms extend from the hub and comprises teeth that engage the cushion.

### CROSS-REFERENCE TO RELATED APPLICATIONS

This application claims the benefit of U.S. provisional application serial no. 63/793,068, filed Apr. 23, 2025, the disclosure of which is hereby incorporated in its entirety by reference herein.

### TECHNICAL FIELD

This relates to a seat assembly, a trim clip, and a method of assembly.

### BRIEF DESCRIPTION OF THE DRAWINGS

FIG. 1 is a perspective view of an example of a seat assembly including a filament mesh structure.

FIG. 2 is schematic view of an example of a manufacturing system for making the filament mesh structure.

FIG. 3 is a magnified view of an example of the filament mesh structure.

FIGS. 4 and 5 are perspective views of a first example of a trim clip.

FIGS. 6 and 7 illustrate installation of the trim clip of FIGS. 4 and 5.

FIG. 8 is a section view of the trim clip of FIGS. 4-7 installed in the filament mesh structure.

FIG. 9 is a plan view of a second example of a trim clip.

FIG. 10 is a perspective view of a third example of a trim clip.

FIGS. 11 and 12 illustrate installation of the trim clip of FIG. 10.

FIG. 13 is a section view of the trim clip of FIGS. 10-12 installed in the filament mesh structure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a” and “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

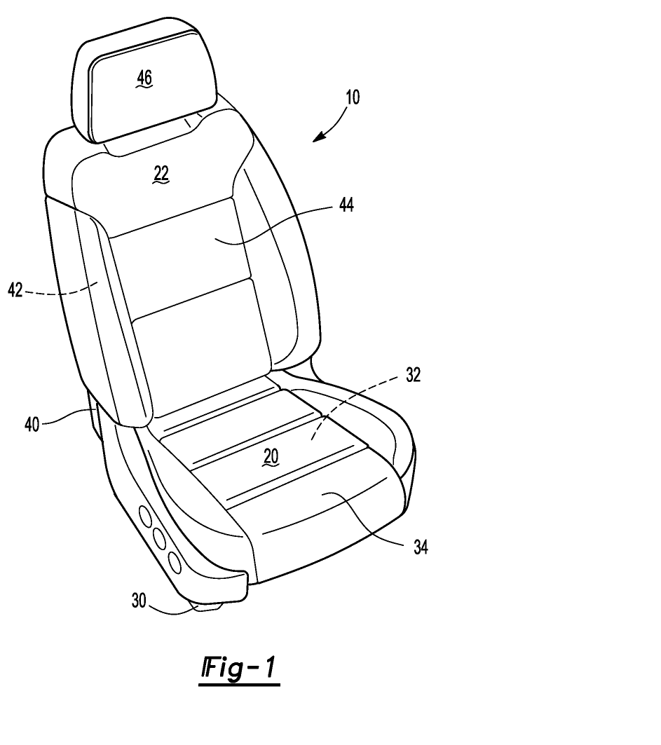

Referring to FIG. 1, an example of a seat assembly 10 is shown. In some embodiments, the seat assembly 10 is a vehicle seat assembly, such as for a land vehicle like a car, truck, bus, or the like, or for a non-land vehicle like aircraft or watercraft. For example, a seat assembly 10 for a land vehicle may be shaped and sized as a front row driver or passenger seat, a second, third, or other rear row seat, and may include bucket-style seats, bench-style seats, or other seat styles. Furthermore, the seat assembly 10 may be a non-stowable seat or a stowable seat that may be foldable and stowable in a cavity in the vehicle floor. Additionally, the seat assembly 10 may be configured for non-vehicle applications such as furniture.

In the configuration shown in FIG. 1, the seat assembly 10 includes a seat bottom 20 and a seat back 22. It is contemplated that the seat back 22 may be omitted in some configurations, such as when the seat assembly 10 is configured as a motorcycle seat or stool.

The seat bottom 20 is configured to receive a seated occupant and support the pelvis or pelvis and thighs of the seat occupant. The seat bottom 20 includes a seat bottom frame 30, a cushion 32, and a trim cover 34.

The seat bottom frame 30 is a structure that supports the cushion 32. The seat bottom frame 30 includes one or more structural members and may be made of any suitable material, such as a metal alloy, polymeric material, fiber reinforced polymeric material, or combinations thereof. In some configurations, the seat bottom frame 30 includes a panel, seat pan, suspension mat, or suspension wires upon which the cushion 32 is disposed.

The cushion 32 is disposed on the seat bottom frame 30. The cushion 32 is made of a compliant material that supports the seat occupant and distributes load forces from the seat occupant to the seat bottom frame 30. The cushion 32 and associated methods of manufacture will be discussed in more detail below.

The trim cover 34 covers at least a portion of the cushion 32. In addition, the trim cover 34 provides one or more visible exterior surfaces of the seat back 22. The seat occupant may be disposed on the trim cover 34 when seated upon the seat assembly 10. The trim cover 34 is made of any suitable material or materials, such as fabric, leather, leatherette, vinyl, or combinations thereof. The trim cover 34 may include a plurality of trim panels that are assembled in any suitable manner, such as by fusing or stitching. The trim cover 34 is attached to the seat bottom frame 30, the cushion 32, or both. For example, the trim cover 34 may include trim attachment features that are attached to the seat bottom frame 30, the cushion 32, or both, to inhibit removal of the trim cover 34 and help conform the trim cover 34 to the contour of the seat bottom frame 30, the cushion 32, or both. In some configurations, the trim cover 34 may also be attached to an attachment pad.

The seat back 22 is configured to support the back of a seated occupant. The seat back 22 is disposed adjacent to the seat bottom 20. For example, the seat back 22 may be disposed above the seat bottom 20 and near the rear side of the seat bottom 20. The seat back 22 extends in a generally upward direction away from the seat bottom 20. In some configurations, the seat back 22 is mounted to the seat bottom 20 and may be pivotable with respect to the seat bottom 20. In other configurations, the seat back 22 is not mounted to the seat bottom 20. For instance, a vehicle seat back may be mounted to the vehicle body structure, such as in some second row seat assemblies. The seat back 22 includes a seat back frame 40, a cushion 42, a trim cover 44, and optionally a head restraint 46.

The seat back frame 40 is a structure that supports the cushion 42. The seat back frame 40 includes one or more structural members and may be made of any suitable material, such as a metal alloy, polymeric material, fiber reinforced polymeric material, or combinations thereof. In some configurations, the seat back frame 40 includes a panel, pan, suspension mat, or suspension wires upon which the cushion 42 is disposed. It is also contemplated that the seat back frame 40 may be integrally formed with the seat bottom frame 30 in some configurations.

The cushion 42 is disposed on the seat back frame 40. The cushion 42 is made of a compliant material that supports the seat occupant and distributes load forces from the seat occupant to the seat back frame 40. It is contemplated that the cushion 42 may be integrally formed with the cushion 32 of the seat bottom 20 or may be separate from the cushion 32 of the seat bottom 20. The cushion 42 and associated methods of manufacture will be discussed in more detail below.

The trim cover 44 covers at least a portion of the cushion 42. In addition, the trim cover 44 provides one or more visible exterior surfaces of the seat back 22. The seat occupant may be disposed on the trim cover 44 when seated upon the seat assembly 10. The trim cover 44 is made of any suitable material or materials, such as fabric, leather, leatherette, vinyl, or combinations thereof. The trim cover 44 may include one trim panel or a plurality of trim panels that are assembled in any suitable manner, such as by fusing or stitching. The trim cover 44 is attached to the seat back frame 40, the cushion 42, or both. For example, the trim cover 44 may include trim attachment features that are attached to the seat back frame 40, the cushion 42, or both, to inhibit removal of the trim cover 44 and help conform the trim cover 44 to the contour of the seat back frame 40, the cushion 42, or both. In some configurations, the trim cover 44 may also be attached to an attachment pad.

The head restraint 46, if provided, is configured to support the head of a seat occupant. The head restraint 46 is disposed at the top of the seat back 22 or at an end of the seat back 22 that is disposed opposite the seat bottom 20. The head restraint 46 may be moveable in one or more directions with respect to the seat back 22 or may be integrally formed with the seat back 22.

Referring to FIG. 3, a fragmentary view of an example of a cushion 50 is shown. The cushion is generically designated with reference number 50 for convenience in reference. It is to be understood that the structure and description of the cushion 50 is applicable to the cushion 32 of the seat bottom 20, the cushion 42 of the seat back 22, or both.

The cushion 50 is a non-foam component or includes at least one non-foam component. The non-foam component is primarily referred to as a mesh member but may also be referred to as a stranded member, looped member, entangled member, filament mesh structure, mesh structure, stranded mesh, looped mesh, entangled mesh, or mesh cushion. In FIG. 3, the cushion 50 is depicted as a non-foam component that does not include a foam component or foam material, such as urethane or polyurethane foam; however, it is contemplated that the cushion 50 may also include a foam component or foam material in addition to a non-foam component to provide additional cushioning or localized cushioning for a seat occupant. For example, foam material may be provided between the cushion 50 and a trim cover (e.g., trim cover 34, 44) that is disposed on the cushion 50, within the cushion 50, or combinations thereof. Reducing the amount of foam material that is provided with the cushion 50 or eliminating foam material from the cushion 50 reduces weight and may improve support and comfort of a seat occupant. In addition, eliminating foam material may facilitate recycling of the cushion 50.

The cushion 50 is described below in the context of a cushion 50 that does not include foam material. In this context, the cushion 50 is made of filaments 52 of polymeric material that are randomly looped, bent, curled, or entangled and are bonded together as will be discussed in more detail below. A filament 52 is directly bonded to another filament 52 rather than being indirectly bonded with a resin or other intermediate material.

The filaments 52, which may also be referred to as strands or threads, are made of any suitable material or materials. In some configurations, the filaments 52 are made of a polymeric material or thermoplastic material, such as a thermoplastic resin that is polyamide-based, polyester-based, polyimide-based, polyolefin-based (e.g., polypropylene-based, polyethylene-based, etc.), polystyrene-based, or combinations thereof. As one example, a polyethylene-based filament may be made of linear low-density polyethylene (LLDPE). The filament material may be recyclable unlike foam material or more easily recycled than foam material. It is also contemplated that a filament 52 may comprise reinforcement fibers and that the reinforcement fibers may not be made of a thermoplastic material.

In some configurations, a filament 52 may be a monofilament that is made of a single material. In some configurations, a filament 52 is made of multiple materials. As an example, a filament 52 made of multiple materials may include a core that is made of a first thermoplastic material and a sheath that encircles the core and is made of a second thermoplastic material that differs from the first thermoplastic material. It is contemplated that the cushion 50 may include a combination of monofilaments and filaments that are made of multiple materials and are not monofilaments.

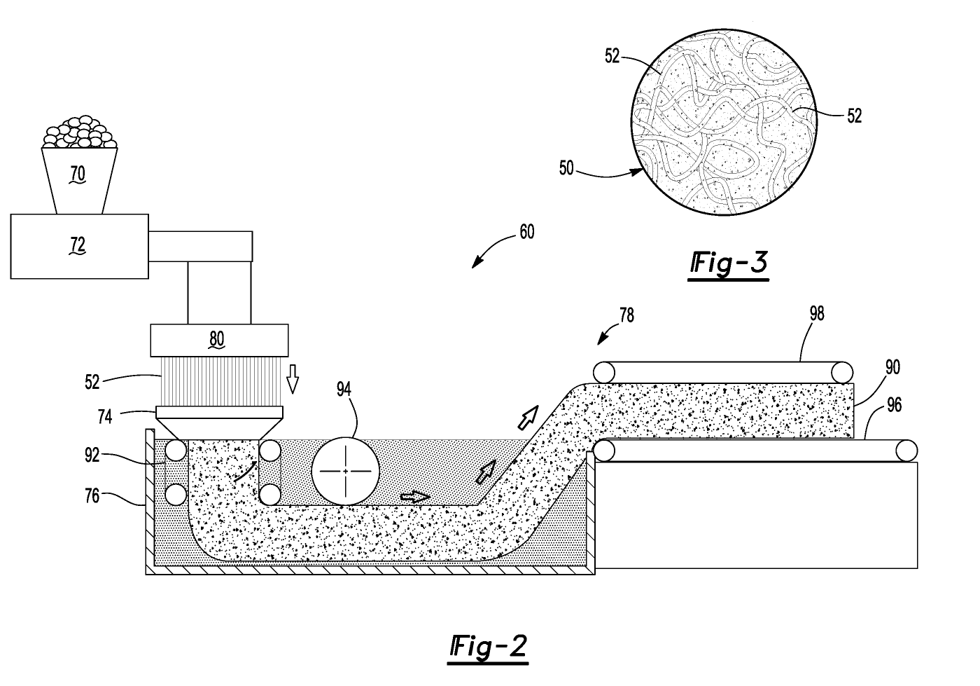

Filaments 52 that are randomly looped, bent, looped, curled, or entangled are bonded together where one filament 52 contacts another filament 52, thereby resulting in a lightweight, air permeable cushion (e.g., cushion 32 and/or 42) or mesh structure having openings or voids between the filaments 52. An example of a manufacturing system 60 of making a cushion or filament mesh structure is also shown in FIG. 2. In this example, the manufacturing system 60 includes a material supply 70, an extruder 72, and a funnel 74. The manufacturing system 60 also includes a cooling tank 76 and a material handling subsystem 78.

Referring to FIG. 2, the material supply 70 holds material stock that is to be extruded, such as solid beads, flakes, granules, pellets, or powder made of the material. In some configurations, the material supply 70 is configured as a container or hopper. The material supply 70 provides material stock to the extruder 72.

The extruder 72 melts the material stock and extrudes the material stock into a set of filaments 52. The extruder 72 may have any suitable configuration. In some configurations, the extruder 72 includes a barrel that receives a rotatable screw and heating elements. Rotation of the screw forces the material to move through the barrel and helps heat the material due to the friction generated as the screw rotates. The material exits the barrel under pressure and in a molten state and is transported under pressure to a die 80 of the extruder 72.

The die 80, which may also be referred to as a die plate or extrusion die, has multiple through holes or filament forming openings through which the molten material passes. A single filament 52 is extruded from each through hole. The filaments 52 fall downward from the die 80 under the force of gravity into the funnel 74.

The funnel 74 consolidates or groups the filaments 52 into a more compact arrangement in which the filaments bend, curl, or loop and a filament 52 contacts and bonds to at least one other filament 52. The funnel 74 has an inlet opening or funnel inlet and an outlet opening or funnel outlet that is smaller than the funnel inlet. Individual separated filaments 52 enter the funnel inlet. The filaments 52 bend, curl, or loop and move into contact as they accumulate. The filaments 52 move through the funnel 74 toward the funnel outlet. Some filaments may slide along the funnel 74 or an intervening sheet that is disposed on the funnel 74 as the filaments move toward the funnel outlet. Bonds are formed between filaments 52 at the points of contact while openings or voids between filaments 52 are present at other locations where one filament 52 does not contact or bond to another filament 52. The entangled and bonded filaments 52 pass through the funnel outlet of the funnel 74 and enter the cooling tank 76. For convenience in reference, the bonded filaments 52 are referred to as a mesh member or filament mesh structure 90.

The cooling tank 76 holds a liquid, such as water or a mixture of water and another fluid. The liquid in the cooling tank 76 helps support the entangled and bonded filaments 52 to limit further compacting or consolidation of the filaments 52 into a less open or less porous arrangement and maintains a desired porosity and density of the filament mesh structure 90. Thus, the liquid provides some buoyancy or resistance that can result in additional bending, curling, or looping of the filaments 52 adjacent to the surface of the liquid or within the funnel 74 to further build the filament mesh structure 90. The liquid also cools the filaments 52 when the filaments 52 are in the liquid. For instance, the liquid cools the filaments 52 from the outside to solidify the filaments 52 and prevent the filaments 52 from bonding at additional locations. At this point, the filaments 52 are relatively stiff and no longer in a plastic state and thus generally maintain a shape and are not moldable or reformable without being reheated.

The material handling subsystem 78 transports the filament mesh structure 90 through the cooling tank 76. The material handling subsystem 78 includes various rollers and conveyors that help move the filament mesh structure 90 through the liquid and out of the liquid. In some configurations, a tractor conveyor 92 is provided in the cooling tank 76 to help pull the filament mesh structure 90 away from the funnel 74 and to counter buoyancy of the filaments 52.

One or more other rollers, such as roller 94, keep the filament mesh structure 90 submerged in the liquid and guide the filament mesh structure 90 through the cooling tank 76. For example, the roller 94 may guide the filament mesh structure 90 toward a conveyor belt 96 and shaker table 98 that are disposed outside of the cooling tank 76. The shaker table 98 shakes the filament mesh structure 90 while it is on the conveyor belt 96 to remove liquid. Alternatively or in addition, the filament mesh structure 90 may be squeezed to remove liquid, air may be blown toward the filament mesh structure 90 to help remove liquid from the filament mesh structure 90, or both. It is also contemplated that the filament mesh structure 90 may also be allowed to drip dry, or dry in ambient air.

The manufacturing system 60 described above is a continuous flow process in which the filament mesh structure 90 is formed as a continuous structure when filament extrusion is not interrupted. Further processing of the filament mesh structure 90 is provided after exiting the cooling tank 76 to cut the filament mesh structure 90 into individual pieces or blanks for individual cushions. Such processing is conducted by a cutting subsystem of the manufacturing system 60. The cutting system may be of any suitable type. For instance, the cutting system may employ a blade, knife, hot knife, saw, fluid jet, or the like to cut the filaments 52 of the filament mesh structure 90 into a blank. The cutting system may be used to shape or contour the blank. It is also contemplated that a blank may be further shaped or contoured with other manufacturing processes, such as molding of the entire blank or a portion thereof.

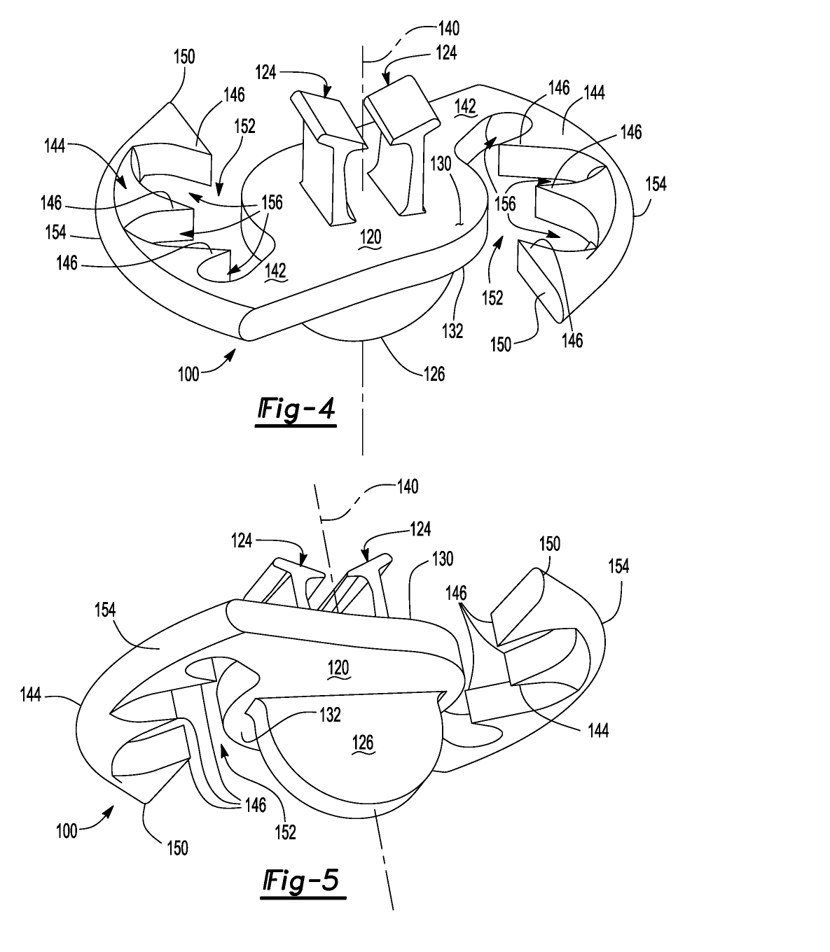

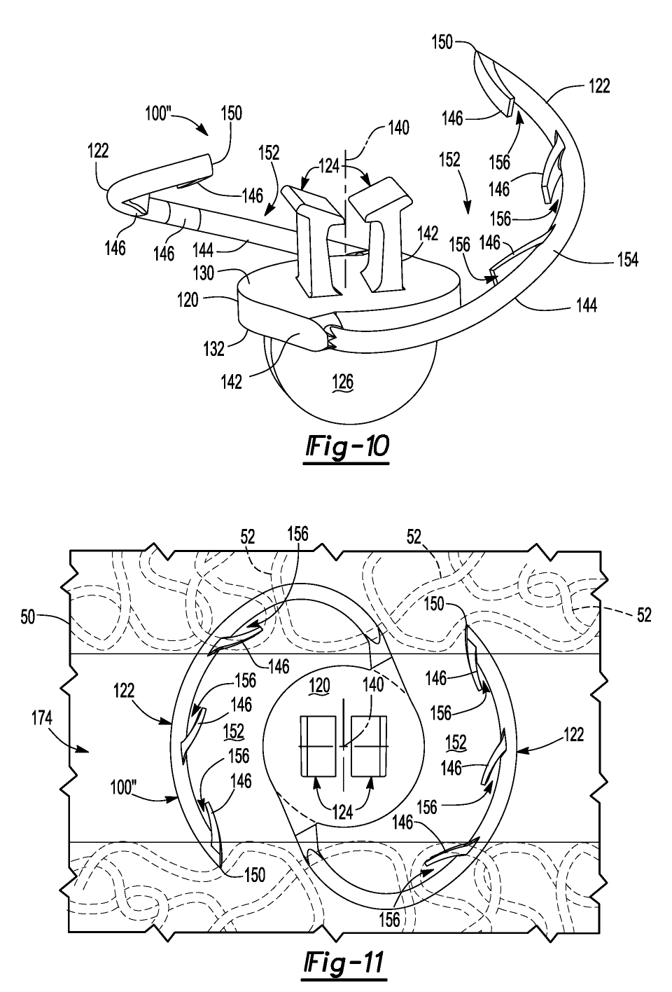

Referring to FIGS. 4-13, examples of trim clips are shown. For convenience in reference, the trim clip is designated with reference number 100 in FIGS. 4-8, reference number 100’ in FIG. 9, and reference number 100’’ in FIGS. 10-13.

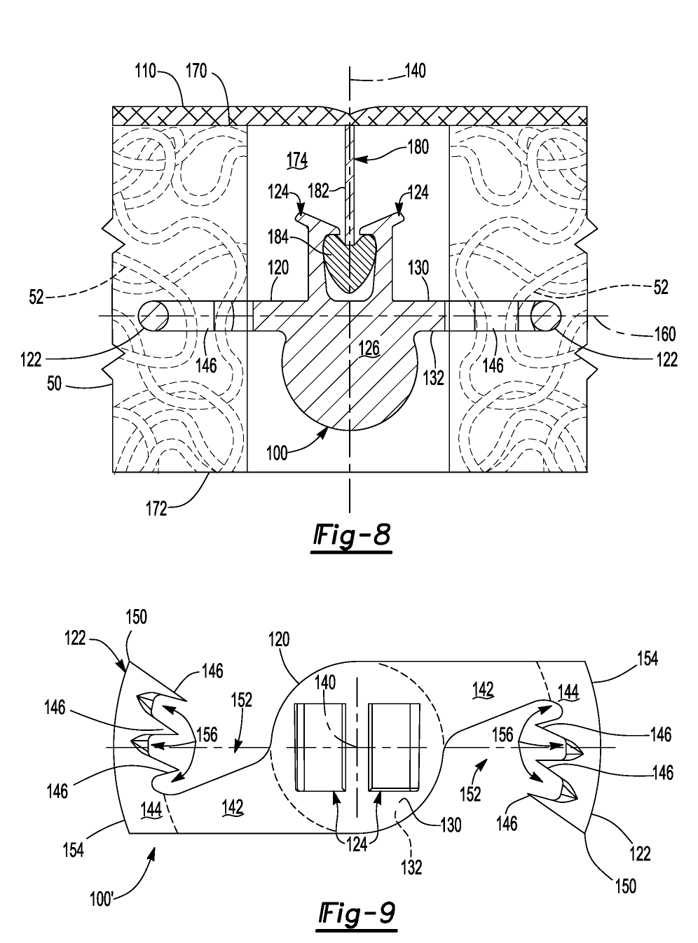

The trim clip 100, 100’, 100’’ is configured to secure a trim cover to a cushion, such as a cushion 50 that includes the filament mesh structure 90. It is also contemplated that the trim clip 100, 100’, 100’’ may also be provided with a cushion that includes foam or is made of foam. Examples of a trim cover secured to a cushion 50 with a trim clip are shown in FIGS. 8 and 13. In these figures, the trim cover is generically designated with reference number 110 for convenience in reference. Accordingly, reference number 110 may designate the trim cover 34 of the seat bottom 20, the trim cover 44 of the seat back 22, or both.

The trim clip 100, 100’, 100’’ is made of any suitable material or materials. In some configurations, the trim clip 100, 100’, 100’’ is made of a polymeric material. The polymeric material may be recyclable. The trim clip 100, 100’, 100’’ or a portion thereof may be made of the same material as the filaments 52, which may facilitate recycling of the cushion 50 and trim clip 100, 100’, 100’’ without removing the trim clip 100, 100’, 100’’ from the cushion 50. It is also contemplated that the trim clip 100, 100’, 100’’ may be made of a material that differs from the filaments 52. The trim clip 100, 100’, 100’’ is manufactured using any suitable process. For instance, the trim clip 100, 100’, 100’’ may be molded or made with an additive manufacturing process, such as 3D printing.

In some configurations, the trim clip 100, 100’, 100’’ comprises a hub 120, one or more arms 122, an attachment feature 124, and an engagement feature 126. One or more features of the trim clip 100, 100’, 100’’ may be integrally formed. For instance, the hub 120, one or more arms 122, the attachment feature 124, the engagement feature 126, or combinations thereof may be manufactured as a unitary one-piece component.

Referring primarily to FIGS. 4, 8, 9, 10, and 13, the hub 120 is configured to engage the cushion 50. For instance, the hub 120 may be configured as a plate, frame, anchor, base, panel, or support from which other features of the trim clip 100, 100’, 100’’ extend. The hub 120 may or may not engage or contact the cushion 50 when installed in the cushion 50. In some configurations, the hub 120 has a first hub side 130 and a second hub side 132.

The first hub side 130 is configured to face toward the trim cover 110 that is secured to the trim clip 100, 100’, 100’’ as shown in FIGS. 8 and 13. In some configurations, the first hub side 130 does not engage or contact one or more filaments 52 of the cushion 50.

In some configurations, the first hub side 130 may be substantially planar. The term “substantially planar” as used herein means lying in a plane or close to lying in a plane with a small variation of the side from its nominally-defined plane, such as a maximum variation across the surface of less than 5% of its diameter (or other maximum lateral extent, in the case of a non-circular surface).

The second hub side 132 is disposed opposite the first hub side 130. In some configurations, the second hub side 132 faces away from the trim cover 110 that is secured to the trim clip 100, 100’, 100’’. In some configurations, the second hub side 132 may be substantially planar. In some configurations, the second hub side 132 may be disposed substantially parallel to the first hub side 130. The term “substantially parallel” as used herein means the same as or very close to parallel and includes features or axes that are within ±3° of being parallel each other.

The hub 120 may help position the trim clip 100, 100’, 100’’ with respect to the cushion 50. The hub 120 is illustrated as being disposed inside the cushion 50 and more specifically in an aperture in the cushion 50 in FIGS. 8 and 13; however, it is contemplated that the hub 120 or a portion thereof may engage, contact, or extend from an exterior side of the cushion 50 in some configurations. The hub 120 may extend along a first axis 140 and may be rotatable about the first axis 140 as will be discussed in more detail below. In some configurations, the first axis 140 may be a center axis or vertical axis that extends through the hub 120.

One or more arms 122 extend from the hub 120. In the configurations shown in FIGS. 4, 9, and 10, two arms 122 are illustrated; however, it is contemplated that a different number of arms 122 may be provided. The arms 122 transmit load forces to the cushion 50. In some configurations, arms 122 may engage the cushion 50 on different or opposite sides of an aperture in the cushion 50 to help resist or prevent the trim clip 100 from being pulled through the aperture in the cushion 50.

An arm 122 partially encircles the hub 120. As such, an arm 122 does not completely encircle, encompass, or extend around the hub 120 or the first axis 140 and thus does not form a continuous loop or ring that encircles or encompasses the hub 120 or the first axis 140, thereby allowing the arm 122 to penetrate or enter the cushion 50 during installation.

An arm 122 extends from the hub 120 to a distal end 150. The distal end 150 is a free end of the arm 122 opposite the hub 120. The distal end 150 is separated from the hub 120 and situated remotely from the point of attachment to the hub 120 or location of the hub 120 from which the arm 122 extends. In some configurations, the arm 122 comprises a first segment 142, a second segment 144, and a set of teeth 146.

The first segment 142 extends from the hub 120. In some configurations, the first segment 142 extends from the hub 120 to the second segment 144. In some configurations, the first segment 142 extends away from the first axis 140. For instance, the first segment 142 protrudes outwardly from the hub 120 or a perimeter of the hub 120 and away from the first axis 140.

The second segment 144 extends from the first segment 142. In some configurations, the second segment 144 extends from an end of the first segment 142 that is disposed opposite the hub 120. The second segment 144 is spaced apart from the hub 120 (e.g., separated from the hub, does not contact the hub, etc.) such that a gap 152 (e.g., opening, aperture, void, open space, etc.) is provided between the second segment 144 and the hub 120. As such, the second segment 144 may extend farther from the first axis 140 or may be positioned farther away from the first axis 140 than the hub 120.

In some configurations, the second segment 144 extends along an arc (e.g., curve, bend, etc.). The arc may have a constant or varying curvature. In some configurations, the second segment 144 may extend along an arc that is radially disposed with respect to the first axis 140. As an example, the second segment 144 may comprise an outer side 154 that faces away from the first axis 140 and that extends along an arc that is radially disposed with respect to the first axis 140. Examples of such a configuration are shown in FIGS. 4 and 9. Such a configuration may allow the arm 122 or the outer side 154 to extend along a circular arc, which may facilitate rotation of the trim clip as will be discussed in more detail below. In some configurations, the arc may not be radially disposed with respect to the first axis 140 or may have a nonconstant curvature. An example of such a configuration is shown in FIG. 10.

The first segment 142 and the second segment 144 may be provided with various lengths or sizes. For instance, the second segment 144 may or may not have a greater length than the first segment 142. In some configurations, such as the example shown in FIG. 4, the second segment 144 has a greater length than the first segment 142. Such a configuration may allow a greater number of teeth to be provided along the second segment 144, may allow the distal end 150 to be more sharply angled to help penetrate the cushion 50 during installation, or both. In some configurations, such as the example shown in FIG. 9, the second segment 144 has a shorter length than the configuration shown in FIG. 4. In the example shown in FIG. 6, the distal end 150 of an arm 122 is generally aligned with the perimeter of the hub 120 (e.g., tangential). This provides a narrower configuration that may be more easily inserted into the cushion 50 prior to rotation and may better accommodate narrower openings or trenches in a cushion 50 in which the trim clip is received.

In some configurations, the hub 120 and the arm 122 may be coplanar. An example of this is shown in FIG. 8. In FIG. 8, the hub 120 and the arm 122 are disposed in a common plane 160, which is represented by a horizontal dashed line. Such a plane may be disposed between the first hub side 130 and the second hub side 132, may extend along the first hub side 130, or may extend along the second hub side 132. An example of a plane 160 that is disposed between the first hub side 130 and the second hub side 132 is represented by the horizontal dashed line in FIG. 8. The plane 160 may be disposed perpendicular to the first axis 140.

In one or more configurations, the hub 120 and the arm 122 may not be coplanar. An example of such a configuration is best shown with the trim clip 100” in FIG. 10. In this configuration, the arm 122 extends away from (e.g., protrudes away from, bends away from, is angled away from, curves away from, spirals away from, etc.) the second hub side 132. As such, the arm 122 may extend above the first hub side 130 and optionally above the attachment feature 124 from the perspective shown. In some configurations, the arm 122 or a portion thereof, such as the second segment 144, may extend farther from the second hub side 132 as the distance from the first axis 140 increases.

The arm 122 may extend in a linear or nonlinear manner away from the second hub side 132. In the example shown in FIG. 10, at least a portion of the arm 122 extends along an arc. In some configurations, the arm 122, and hence the arc, extends partially around the first axis 140, which may make it easier to rotate the trim clip 100’’ between filaments 52 of the cushion 50 during installation. The arc or curve may or may not be radially disposed with respect to the first axis 140. For instance, the arm 122 may extend along an arc that does not have a constant radius of curvature in one or more configurations.

Referring primarily to FIGS. 4, 9, and 10, the set of teeth 146 is provided with the arm 122. The set of teeth 146 includes one or more teeth 146. One or more members of the set of teeth 146 may engage a filament 52 or multiple filaments 52 to help secure the trim clip 100, 100’, 100’’ to the cushion 50 as will be discussed in more detail below.

A tooth 146 or teeth 146 may have any suitable configuration or configurations. For instance, a tooth 146 may be configured as a protrusion, prong, or hook. In a set of teeth having multiple teeth, some or all of the teeth 146 may have the same configuration or different configurations. A recess 156 is provided between a tooth 146 and a portion of the arm 122 such as the second segment 144, between adjacent teeth 146 when multiple teeth 146 are provided, or both.

In some configurations, the set of teeth 146 extends from the second segment 144 of the arm 122. For instance, a tooth 146 may extend from the second segment 144 toward the first axis 140 but may not extend to the hub 120. As such, the gap 152 may be disposed between the hub 120 and the set of teeth 146. It is also contemplated that teeth 146 may be provided that extend away from the first axis 140 in one or more configurations. Orienting the set of teeth toward the first axis 140 may make the trim clip 100, 100’, 100’’ more compact and may make it easier to rotate the trim clip 100, 100’, 100’’ about the first axis 140 as compared to configurations in which the set of teeth 146 extend away from the first axis 140.

In some configurations, members of the set of teeth 146 extend away from (e.g., point away from, are angled away from, etc.) the distal end 150. Orienting the set of teeth 146 in this manner may allow the trim clip 100, 100’, 100’’ to be more easily rotated in a first direction to extend the arm 122 between filaments 52 and into the cushion 50 and may allow the set of teeth 146 to capture or engage a filament 52 to resist rotation in a second direction that is opposite the first direction.

Referring primarily to FIGS. 4, 8, and 13, the attachment feature 124 is configured to help secure the trim cover 110. For instance, the attachment feature 124 may be coupled to a trim attachment feature 180 of the trim cover 110. In some configurations, the attachment feature 124 may engage or contact a trim attachment feature 180 of the trim cover 110 as shown in FIGS. 8 and 13. In some configurations, the attachment feature 124 extends from the first hub side 130 of the hub 120. The attachment feature 124 may extend away from the second hub side 132.

The attachment feature 124 may have any suitable configuration. For instance, the attachment feature 124 may have a male configuration, a female configuration, or combinations thereof. For instance, an attachment feature 124 having a male configuration may comprise a barb, hook, bead, ball, protrusion, or the like. An attachment feature 124 having a female configuration may comprise a socket, hole, a recess, opening, indentation, cavity, or the like. It is contemplated that trim attachment feature 180 of the trim cover 110 may be directly or indirectly coupled to the attachment feature 124. As an example, the trim attachment feature 180 and attachment feature 124 may be configured to mate with each other and be directly coupled. As another example, the trim attachment feature 180 may be indirectly coupled to the attachment feature 124 with an intervening fastener, such as a ring or linkage that may encircle the attachment feature 124 and the trim attachment feature 180.

Referring primarily to FIGS. 4, 5, 8, 10 and 13, the engagement feature 126, if provided, is configured to facilitate rotation of the trim clip 100, 100’, 100’’. For instance, the engagement feature 126 may be engaged or grasped manually or with a tool to rotate the trim clip 100, 100’, 100’’ about the first axis 140 as will be discussed in more detail below. In some configurations, the engagement feature 126 extends from the second hub side 132.

The engagement feature 126 may have any suitable configuration. For example, the engagement feature 126 may have a male configuration, a female configuration, or combinations thereof. In some configurations, an engagement feature 126 having a male configuration may comprise a protrusion, head, or paddle that may be manually engaged or engaged with a tool, such as a wrench, pliers, socket, or the like. An engagement feature 126 may have multiple sides or flats (e.g., a hex head or the like) that may be engageable with a tool that rotates the trim clip 100, 100’, 100’’. In some configurations, an engagement feature 126 having a female configuration may comprise a socket, hole, recess, indentation, slot, or the like that may receive a compatible tool, such as a driver head or driver bit (e.g., flat head, Phillips head, star shaped head like a Torx® head, etc.). It is contemplated that an engagement feature 126 having a female configuration may extend into or be provided with the hub 120. It is also contemplated that the engagement feature 126 may be omitted and other features of the trim clip 100, 100’, 100’’, such as the hub 120 or the attachment feature 124, may be engaged to rotate the trim clip 100, 100’, 100’’.

Installation of a trim clip 100, 100’, 100’’ into a cushion 50 will now be discussed. The cushion 50 is primarily discussed with reference to FIGS. 6-8 and 11-13. In these figures, a simplified version of the cushion 50 is shown in which some filaments are omitted. For instance, in these figures, examples of filaments 52 are shown in phantom so that the trim clip is more readily visible. In FIGS. 8 and 11, filaments 52 are generally shown in phantom behind the section plane and filaments 52 that intersect the section plane are not illustrated as being sectioned for clarity. In addition, many filaments 52 are omitted in FIG. 13 and only a few filaments are 52 are shown that engage a tooth 146 of a trim clip for simplicity.

Referring to FIGS. 8 and 13, the cushion 50 comprises multiple sides. In some configurations, the cushion 50 includes a first side 170 and a second side 172. The cushion 50 may also comprise one or more apertures 174.

The first side 170 faces toward the trim cover 110, a seat occupant, or both. In some configurations, the trim cover 110 is disposed on the first side 170 and may engage or contact the first side 170.

The second side 172 is disposed opposite the first side 170. As such, the second side 172 may be a back side or underside of the cushion 50 that faces away from a seat occupant that is disposed on or seated on the seat assembly 10.

One or more apertures 174 (e.g., hole, opening, slit, slot, through hole, etc.) may be provided that extend from the first side 170 to or toward the second side 172. In some configurations, an aperture 174 may be configured as a cut or void in the cushion 50 that extends from the first side 170 to the second side 172. Such a configuration may facilitate access to the engagement feature 126 from the second side 172 to facilitate rotation of the trim clip, insertion of the trim clip into the cushion 50, or both. In some configurations, the aperture 174 extends from the first side 170 toward the second side 172 but not to the second side 172. The trim clip 100, 100’, 100’’ may be at least partially disposed in the aperture 174. For instance, the attachment feature 124 and the engagement feature 126 may be disposed in the aperture 174 in one or more configurations.

The trim cover 110 comprises a trim attachment feature 180. The trim attachment feature 180 may extend from a side of the trim cover 110 that faces toward the cushion 50. The trim attachment feature 180 is insertable into the aperture 174 of the cushion 50. As such, the trim attachment feature 180 may be at least partially disposed in the aperture 174 of the cushion 50 when the trim cover 110 is installed.

In some configurations, the trim attachment feature 180 is coupled to the attachment feature 124 of the trim clip 100, 100’, 100’’. For instance, the trim attachment feature 180 is securable, attachable to, or engageable with the attachment feature 124. The trim attachment feature 180 may have any suitable configuration that is compatible with the attachment feature 124 of the trim clip 100, 100’, 100’’. For instance, the trim attachment feature 180 may have a male configuration, a female configuration, or combinations thereof. In some configurations, it is contemplated that a fastener, such as a ring or band, may encircle the attachment feature 124 and the trim attachment feature 180 to couple the trim cover 110 to the trim clip 100, 100’, 100’’. In some configurations, the trim attachment feature 180 includes a strip 182 and a head 184.

The strip 182 extends from and may be attached to one or more panels of the trim cover 110. In some configurations, the strip 182 may be flexible and may be fabric, a polymeric material, cord, or the like.

The head 184 may be disposed at a distal end of the strip 182. For instance, the head 184 may be disposed at a free end of the strip 182 that is detached from or does not contact a panel of the trim cover 110. In some configurations, the head 184 is configured as an enlarged bead, rod, shaft, or other member that is secured to the strip 182.

The method of installation described below may be applicable to any of the trim clip configurations previously discussed but will be primarily described with reference to trim clip 100 and FIGS. 4-8 for brevity. Accordingly, although trim clip 100 is primarily referenced in the following paragraphs, it is to be understood that the method is applicable to trim clip 100’ and trim clip 100” as well.

First, the trim clip 100 is inserted into the cushion 50. For example, the trim clip 100 may be aligned with the aperture 174 in the cushion 50 such that the trim clip 100 is insertable into the aperture 174.

In some configurations, the trim clip 100 may be aligned such that the hub 120 is insertable into the aperture 174 and some or all of an arm 122 is insertable or fittable into the aperture 174. In the example shown in FIG. 6, the aperture 174 is approximately the same size as the hub 120 and the trim clip 100 is oriented or rotated with respect to the first axis 140 such that a majority of the arm 122 is aligned with the aperture 174 to facilitate insertion. For instance, the trim clip 100 may be oriented such that the set of teeth 146 is entirely or at least partially aligned with the aperture 174 and then the trim clip 100 may be pushed into the aperture 174, such as pushed toward the second side 172 of the cushion 50 when the trim clip 100 enters the aperture 174 from the first side 170 of the cushion 50. It is contemplated that the entire trim clip may fit into the aperture 174 without contacting the cushion 50. It is also contemplated that a portion of the trim clip may fit into the aperture 174 without contacting the cushion 50. For instance, one or more arms 122 may contact the cushion 50 during insertion and may be pushed or pulled along or past one or more filaments 52 during insertion of the trim clip. It is contemplated that an arm 122 may be sufficiently stiff to deform the cushion 50 or push filaments 52 of the cushion 50 outward during installation and thus change the shape of the aperture 174 from what is shown in FIGS. 6 and 11, noting that FIGS. 6 and 11 are simplified and show examples of filament and arm positioning after insertion. For instance, the arms 122 may push on filaments and widen a portion of the aperture 174 during insertion. It is also contemplated that the cushion 50 may be sufficiently stiff to bend, deform, or reposition an arm 122 during insertion and thus change the positioning of an arm 122 with respect to its free state or state before insertion.

The trim clip 100 may be inserted into the aperture 174 to a sufficient depth that the trim clip 100 will not be felt by a seat occupant. In FIG. 8, the trim clip 100 is inserted to a depth such that the entire trim clip 100 is positioned between the first side 170 and the second side 172 of the cushion 50; however, the depth of insertion may be greater than or less than that shown in FIG. 8. At least the arm 122 is positioned between the first side 170 and the second side 172 of the cushion 50 once the trim clip 100 is inserted. In some configurations, a filament 52 is not received in the gap 152 after the trim clip is inserted into the aperture and before the trim clip is rotated.

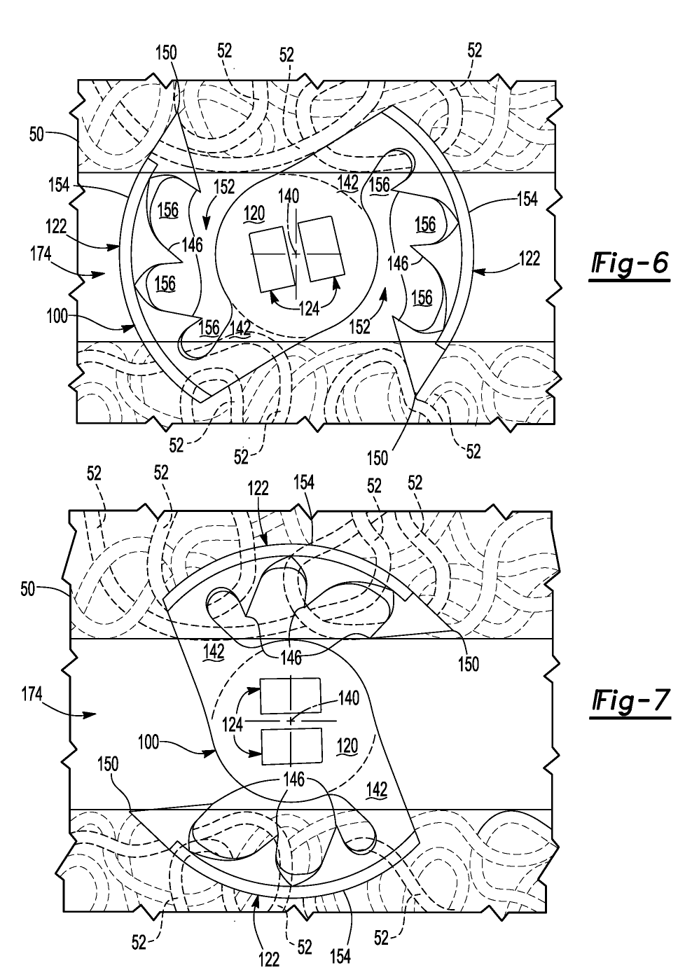

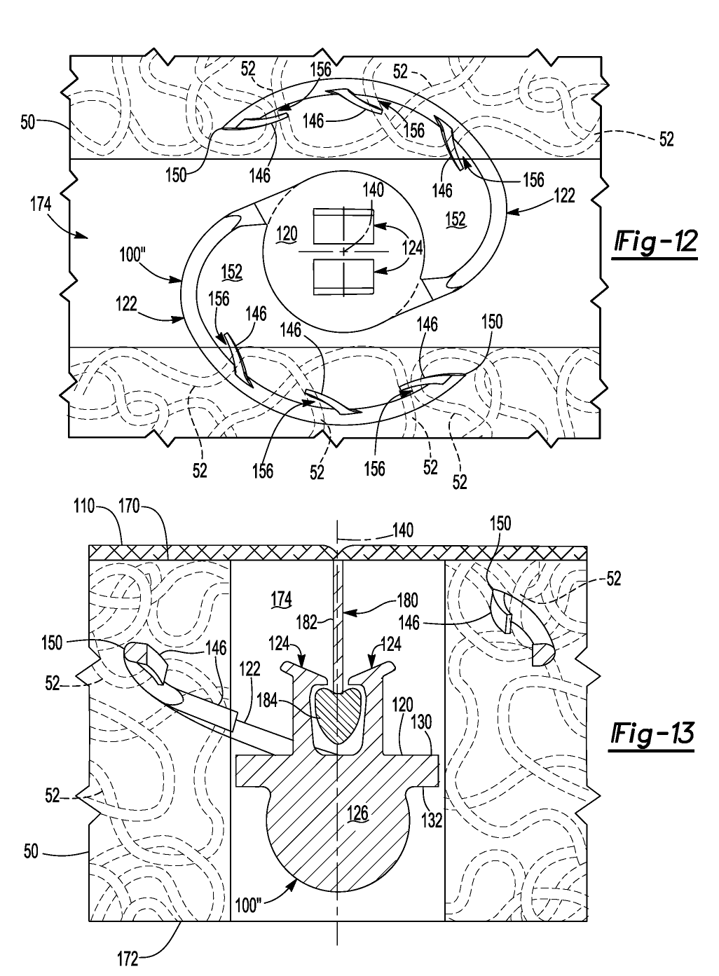

Second, the trim clip 100 is rotated with respect to the cushion 50. The trim clip 100 is rotated to extend the arm 122 into the cushion 50 so that one or more filaments 52 are captured (e.g., seized, engaged, grabbed, snagged, ensnared, hook, trapped, etc.) by the arm 122, such as between the arm 122 and the hub 120. Rotating the trim clip 100 with respect to the cushion 50 may include rotating the trim clip 100 about the first axis 140 and a first direction (e.g., clockwise direction when viewed from above the first hub side 130 in the example shown in FIGS. 6 and 7 and a counterclockwise direction when viewed from above the first hub side 130 in the configuration shown in FIGS. 11 and 12).

Rotation of the trim clip 100 extends or advances the arm 122 into the cushion 50 and forces the arm 122 between filaments 52 of the cushion 50. An arm 122 may be flexible so that the arm 122 can maneuver between filaments 52 when the trim clip 100 is rotated. In the configuration in FIG. 8, the arms 122 may rotate in a plane 160 that is perpendicular to the first axis 140. In the configuration in FIG. 12, the arms 122 may not rotate in a plane that is perpendicular to the first axis 140 since the arms 122 extend away from the second hub side 132.

A filament 52 may slide past or slide around the distal end 150 of the arm 122 and over a side or flank of one or more teeth 146 as the trim clip 100 is rotated. In some configurations, a filament 52 that is engaged by at least one member of the set of teeth 146 may enter the gap 152 when the trim clip 100 is rotated in the first direction and may enter or be received in a recess 156 or between two adjacent members of the set of teeth 146 upon sufficient rotation of the trim clip 100. Thus, in some configurations a filament 52 that is engaged by at least one member of the set of teeth 146 may be received in the recess 156.

At least one member of the set of teeth 146 engages a filament 52 to resist rotation of the trim clip 100 about the first axis 140 in a second direction (e.g., counterclockwise direction in the example shown in FIGS. 6 and 7, clockwise direction in the example shown in FIGS. 11 and 12) that is disposed opposite the first direction. (It is noted that the first and second directions can be reversed as compared to these examples.) Examples of filaments 52 that engage or are captured by a tooth 146 and are disposed in a recess 156 are numbered in FIGS. 7, 8, 12, and 13.

As shown by comparing FIGS. 6 and 7 (or FIGS. 11 and 12), the set of teeth 146 may be at least partially disposed in the aperture 174 before rotating the trim clip 100 with respect to the cushion 50 and the set of teeth 146 may be at least partially disposed in the filament mesh structure 90 of the cushion 50 after rotating the trim clip 100 with respect to the cushion 50 to the position shown in FIG. 7 (or FIG. 12). The trim clip 100 may be rotated manually or with a tool as previously discussed.

The trim clip may be rotated by any sufficient amount to capture one or more filaments 52. In the examples shown in FIGS. 7 and 12, the trim clip is rotated by 90 degrees with respect to the positions shown in FIGS. 6 and 11; however, the amount of rotation employed may be greater or lesser than that shown.

Third, the trim cover 110 is coupled to the trim clip 100. The trim cover 110 may be coupled to the trim clip 100 by engaging or coupling the trim attachment feature 180 to the attachment feature 124 as previously discussed.

The present invention may provide more secure retention of a trim clip in a cushion as compared to other trim clip designs. Moreover, the trim clip may be compatible with a cushion that comprises a filament mesh structure. The arms that extend from the hub of the trim clip may allow a trim clip to be secured to a cushion that has an aperture that is a through hole or when sufficient filaments are not present or underneath the trim clip to provide adequate retention. The present invention also allows a trim clip to be installed in a cushion in a self-retaining manner or preassembled such that a cushion with a trim clip can be handled or transported without the trim clip disengaging or falling out of the cushion and without loss of a desired trim clip location with respect to the cushion, which may provide material handling or process flow improvements and avoid repair or reassembly steps which may increase assembly time and associated costs.

Clause 1. A trim clip comprising: a hub extending along a first axis; one or more arms extending from the hub and partially encircling the hub, at least one of the one or more arms comprising a set of teeth; and an attachment feature extending from the hub.

Clause 2. The trim clip of clause 1 wherein the set of teeth faces toward the first axis.

Clause 3. The trim clip of clause 1 or clause 2 wherein at least one of the one or more arms comprises a first segment extending from the hub and a second segment extending from the first segment, wherein the second segment comprises the set of teeth.

Clause 4. The trim clip of clause 3 wherein the first segment extends away from the first axis.

Clause 5. The trim clip of clause 3 or clause 4 further comprising a gap between the second segment and the hub.

Clause 6. The trim clip of any one of clauses 3 to 5 wherein the second segment extends along an arc.

Clause 7. The trim clip of any one of clauses 3 to 6 wherein the second segment comprises an outer side that faces away from the first axis and is radially disposed with respect to the first axis.

Clause 8. The trim clip of any preceding clause wherein at least one of the one or more arms comprises a distal end opposite the hub and the set of teeth extends away from the distal end.

Clause 9. The trim clip of any preceding clause wherein the attachment feature extends from a first hub side of the hub and an engagement feature extends from a second hub side of the hub disposed opposite the first hub side.

Clause 10. The trim clip of any preceding clause wherein the hub and at least one of the one or more arms are coplanar.

Clause 11. The trim clip of any one of clauses 1 to 9 wherein the hub comprises a first hub side and a second hub side opposite the first hub side, and wherein at least one of the one or more arms extends away from the second hub side.

Clause 12. The trim clip of clause 11 wherein the attachment feature extends from the first hub side.

Clause 13. The trim clip of clause 11 or clause 12 wherein at least one of the one or more arms extends along an arc that extends partially around the first axis.

Clause 14. A seat assembly comprising: a cushion, the cushion comprising a mesh member, the mesh member comprising a set of filaments of thermoplastic material, wherein each member of the set of filaments is bonded to at least one other member of the set of filaments; a trim cover engaging the cushion, the trim cover comprising at least one trim attachment feature; and a trim clip comprising: a hub extending along a first axis; one or more arms extending from the hub and partially encircling the hub, at least one of the one or more arms comprising a set of teeth, wherein at least one member of the set of teeth engages a filament; and an attachment feature extending from the hub, wherein the attachment feature engages the trim attachment feature.

Clause 15. The seat assembly of clause 14 wherein a gap is disposed between the hub and at least one of the one or more arms of the trim clip and the filament engaged by at least one member of the set of teeth is in the gap.

Clause 16. The seat assembly of clause 15 wherein the gap comprises a recess between two adjacent members of the set of teeth and the filament engaged by at least one member of the set of teeth is in the recess.

Clause 17. The seat assembly of any one of clauses 14 to 16 wherein at least one of the one or more arms comprises a distal end opposite the hub and the set of teeth extends away from the distal end.

Clause 18. The seat assembly of any one of clauses 14 to 17 wherein the cushion comprises a first side that faces toward the trim cover and a second side opposite the first side, and wherein at least one of the one or more arms is positioned in the cushion between the first side and the second side.

Clause 19. A method comprising: inserting a trim clip into a cushion, the trim clip comprising a hub extending along a first axis, one or more arms extending from the hub and partially encircling the hub, at least one of the one or more arms comprising a set of teeth, and the cushion comprising a mesh member, the mesh member comprising a set of filaments of thermoplastic material, wherein each member of the set of filaments is bonded to at least one other member of the set of filaments; and rotating the trim clip with respect to the cushion, wherein rotating the trim clip extends at least one of the one or more arms into the cushion and captures a filament between at least one of the one or more arms and the hub.

Clause 20. The method of clause 19 wherein rotating the trim clip with respect to the cushion comprises rotating the trim clip about the first axis in a first direction, and wherein at least one member of the set of teeth engages the filament to resist rotation of the trim clip about the first axis in a second direction.

Clause 21. The method of clause 19 or clause 20 wherein inserting the trim clip into the cushion comprises inserting the trim clip into an opening in the cushion, the opening extending from a first side of the cushion toward a second side of the cushion, wherein the set of teeth is at least partially in the opening before rotating the trim clip with respect to the cushion and the set of teeth is at least partially in the mesh member after rotating the trim clip with respect to the cushion.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A trim clip comprising:
a hub extending along a first axis;
one or more arms extending from the hub and partially encircling the hub, at least one of the one or more arms comprising a set of teeth; and
an attachment feature extending from the hub.

2. The trim clip of claim 1 wherein the set of teeth faces toward the first axis.

3. The trim clip of claim 1 wherein at least one of the one or more arms comprises a first segment extending from the hub and a second segment extending from the first segment, wherein the second segment comprises the set of teeth.

4. The trim clip of claim 3 wherein the first segment extends away from the first axis.

5. The trim clip of claim 3 further comprising a gap between the second segment and the hub.

6. The trim clip of claim 3 wherein the second segment extends along an arc.

7. The trim clip of claim 3 wherein the second segment comprises an outer side that faces away from the first axis and is radially disposed with respect to the first axis.

8. The trim clip of claim 1 wherein at least one of the one or more arms comprises a distal end opposite the hub and the set of teeth extends away from the distal end.

9. The trim clip of claim 1 wherein the attachment feature extends from a first hub side of the hub and an engagement feature extends from a second hub side of the hub disposed opposite the first hub side.

10. The trim clip of claim 1 wherein the hub and at least one of the one or more arms are coplanar.

11. The trim clip of claim 1 wherein the hub comprises a first hub side and a second hub side opposite the first hub side, and wherein at least one of the one or more arms extends away from the second hub side.

12. The trim clip of claim 11 wherein the attachment feature extends from the first hub side.

13. The trim clip of claim 11 wherein at least one of the one or more arms extends along an arc that extends partially around the first axis.

14. A seat assembly comprising:
a cushion, the cushion comprising a mesh member, the mesh member comprising a set of filaments of thermoplastic material, wherein each member of the set of filaments is bonded to at least one other member of the set of filaments;
a trim cover engaging the cushion, the trim cover comprising at least one trim attachment feature; and
a trim clip comprising:
a hub extending along a first axis;
one or more arms extending from the hub and partially encircling the hub, at least one of the one or more arms comprising a set of teeth, wherein at least one member of the set of teeth engages a filament; and
an attachment feature extending from the hub, wherein the attachment feature engages the trim attachment feature.

15. The seat assembly of claim 14 wherein a gap is disposed between the hub and at least one of the one or more arms of the trim clip and the filament engaged by at least one member of the set of teeth is in the gap.

16. The seat assembly of claim 15 wherein the gap comprises a recess between two adjacent members of the set of teeth and the filament engaged by at least one member of the set of teeth is in the recess.

17. The seat assembly of claim 14 wherein at least one of the one or more arms comprises a distal end opposite the hub and the set of teeth extends away from the distal end.

18. The seat assembly of claim 14 wherein the cushion comprises a first side that faces toward the trim cover and a second side opposite the first side, and wherein at least one of the one or more arms is positioned in the cushion between the first side and the second side.

19. A method comprising:
inserting a trim clip into a cushion, the trim clip comprising a hub extending along a first axis, one or more arms extending from the hub and partially encircling the hub, at least one of the one or more arms comprising a set of teeth, and the cushion comprising a mesh member, the mesh member comprising a set of filaments of thermoplastic material, wherein each member of the set of filaments is bonded to at least one other member of the set of filaments; and
rotating the trim clip with respect to the cushion, wherein rotating the trim clip extends at least one of the one or more arms into the cushion and captures a filament between at least one of the one or more arms and the hub.

20. The method of claim 19 wherein rotating the trim clip with respect to the cushion comprises rotating the trim clip about the first axis in a first direction, and wherein at least one member of the set of teeth engages the filament to resist rotation of the trim clip about the first axis in a second direction.
